(19) United States
(12) Patent Application Publication
(10) Pub. No.: US 2026/0018127 A1
(43) Pub. Date: Jan. 15, 2026

(54) DISPLAY DEVICE AND ELECTRONIC DEVICE INCLUDING THE SAME

(71) Applicant: Samsung Display Co., Ltd., Yongin-si (KR)

(72) Inventors: Kon Haeng LEE, Yongin-si (KR); Chang Woo KAHNG, Yongin-si (KR); Won Tae KIM, Yongin-si (KR); Jung Kook PARK, Yongin-si (KR); Joon Hyuk YANG, Yongin-si (KR); Seok Hyun JUNG, Yongin-si (KR)

(21) Appl. No.: 19/175,843

(22) Filed: Apr. 10, 2025

(30) Foreign Application Priority Data
Jul. 10, 2024 (KR) 10-2024-0091234

(51) Int. Cl. G09G 3/3233

(52) U.S. Cl. CPC G09G 3/3233; G09G 2300/0819; G09G 2300/0842; G09G 2300/0861; G09G 2310/0254; G09G 2330/021

(57) ABSTRACT

A display device includes: a substrate; a first pixel on the substrate; a second pixel on the substrate and surrounded by a light blocking layer; a data line connected to the first and second pixels; first and second gate lines connected to the first and second pixels, respectively; a first initialization voltage line transmitting a first initialization voltage; and a second initialization voltage line configured transmitting a second initialization voltage, wherein, in a first mode, the first initialization voltage has a voltage of a magnitude capable of turning on a first transistor of the first pixel, in a second mode, the first initialization voltage has a voltage of a magnitude capable of turning off the first transistor of the first pixel, and in the first and second modes, the second initialization voltage has a voltage of a magnitude capable of turning on the first transistor of the second pixel.

### CROSS-REFERENCE TO RELATED APPLICATION

The present application claims priority to and the benefit of Korean Patent Application No. 10-2024-0091234, filed on Jul. 10, 2024, in the Korean Intellectual Property Office, the entire disclosure of which is incorporated herein by reference.

### BACKGROUND

### 1. Field

Aspects of some embodiments of the present disclosure relate to a display device and an electronic device including the same.

### 2. Description of the Related Art

With the advancement of the information age, consumer demand for display devices for displaying images has increased with various forms. For example, the display device has been applied to various electronic devices such as a smart phone, a digital camera, a laptop computer, a navigator, or a smart television.

A display device may be a flat panel display device such as a liquid crystal display device, a field emission display device, or a light emitting display device. The light emitting display device includes an organic light emitting display device that includes an organic light emitting element, an inorganic light emitting display device that includes an inorganic light emitting element such as an inorganic semiconductor, and a micro light emitting display device that includes a micro light emitting element.

The above information disclosed in this Background section is only for enhancement of understanding of the background and therefore the information discussed in this Background section does not necessarily constitute prior art.

### SUMMARY

Aspects of some embodiments of the present disclosure relate to a display device and an electronic device including the same, and for example, to a display device in which power consumption may be relatively reduced.

Aspects of some embodiments of the present disclosure include a display device in which power consumption may be relatively reduced.

Aspects of some embodiments of the present disclosure are not limited to those mentioned above and additional aspects of some embodiments of the present disclosure, which are not mentioned herein, will be clearly understood by those skilled in the art from the following description of the present disclosure.

According to some embodiments of the present disclosure, a display device includes: a substrate; a first pixel on the substrate and not surrounded by a light blocking layer; a second pixel on the substrate and surrounded by the light blocking layer; a data line connected to the first pixel and the second pixel; a first gate line connected to the first pixel; a second gate line connected to the second pixel; a first initialization voltage line connected to the first pixel, transmitting a first initialization voltage; and a second initialization voltage line connected to the second pixel, transmitting a second initialization voltage, wherein, in a first mode, the first initialization voltage has a voltage of a magnitude capable of turning on a first transistor of the first pixel, in a second mode, the first initialization voltage has a voltage of a magnitude capable of turning off the first transistor of the first pixel, and in the first mode and the second mode, the second initialization voltage has a voltage of a magnitude capable of turning on the first transistor of the second pixel.

According to some embodiments of the present disclosure, in a display device, power consumption of the display device may be relatively reduced. For example, in a second mode (e.g., a private mode), because a first transistor of a wide rendering group is turned off and a first transistor of a narrow rendering group is turned on, a light emitting element of the wide rendering group does not emit light in the second mode. Therefore, according to some embodiments of the present disclosure, in a display device, because there may be no substantial change in a data signal between a first period and a second period of the second mode, power consumption of the display device may be relatively reduced even though pixels of the wide rendering group and pixels of the narrow rendering group are driven differently from each other.

The effects according to the embodiments of the present disclosure are not limited to those mentioned above and more various effects are included in the following description of the present disclosure.

### BRIEF DESCRIPTION OF THE DRAWINGS

The above and other aspects and features of some embodiments of the present disclosure will become more apparent by describing in more detail aspects of some embodiments thereof with reference to the attached drawings, in which:

FIG. 1 is a schematic plan view illustrating a display device according to some embodiments;

FIG. 2 is a schematic plan view illustrating an arrangement structure of a plurality of data lines and a plurality of conductive lines of a circuit board according to some embodiments;

FIG. 3 is a plan view illustrating an arrangement of pixels and a light blocking layer of a display device according to some embodiments;

FIG. 4 is an enlarged view illustrating an area A of FIG. 3;

FIG. 5 is a cross-sectional view taken along the line I-I′ of FIG. 4;

FIG. 6 is a cross-sectional view illustrating a moving path of light in FIG. 5 in an environment having a wide viewing angle;

FIG. 7 is a view illustrating an operation of pixels when a display device according to some embodiments is driven in a first mode;

FIG. 8 is a view illustrating an operation of pixels when a display device according to some embodiments is driven in a second mode;

FIG. 9 is a view illustrating an equivalent circuit of pixels included in a wide rendering group;

FIG. 10 is a view illustrating an equivalent circuit of pixels included in a narrow rendering group; and

FIG. 11 is a view illustrating initialization voltage lines connected to pixels of a wide rendering group and pixels of a narrow rendering group in a display device according to some embodiments.

FIG. 12 is a block diagram of an electronic device according to one embodiment.

FIGS. 13, 14 and 15 are schematic diagrams of electronic devices according to various embodiments.

### DETAILED DESCRIPTION

The present invention will now be described more fully hereinafter with reference to the accompanying drawings, in which aspects of some embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

It will also be understood that when a layer is referred to as being “on” another layer or substrate, it can be directly on the other layer or substrate, or intervening layers may also be present. The same reference numbers indicate the same components throughout the specification. In the attached figures, the thickness of layers and regions is exaggerated for clarity.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

Features of various embodiments of the present disclosure may be combined partially or totally. As will be clearly appreciated by those skilled in the art, technically various interactions and operations are possible. Various embodiments can be practiced individually or in combination.

Hereinafter, specific exemplary embodiments will be described with reference to the accompanying drawings.

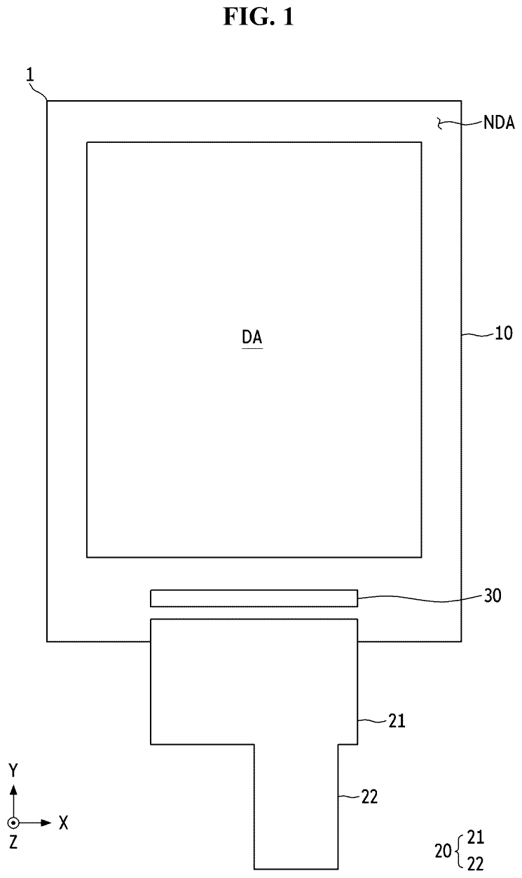

FIG. 1 is a schematic plan view illustrating a display device according to some embodiments.

In the present disclosure, a first direction X, a second direction Y, and a third direction Z are indicated.

The first direction X may be a direction parallel with one side of a display device 1 when viewed on a plane, for example, a horizontal direction of the display device 1. The second direction Y may be a direction parallel with the other side that is in contact with one side of the display device 1 when viewed on a plane (or in a plan view), and may be a vertical direction of the display device 1. The third direction Z may be a thickness direction of the display device 1. Hereinafter, for convenience of description, one side in the first direction X refers to a right direction on a plan view and the other side in the first direction X refers to a left direction on a plan view, and one side in the second direction Y refers to an upper direction on a plan view and the other side in the second direction Y refers to a lower direction on a plan view. In addition, one side in the third direction Z refers to an upper direction on a cross-sectional view, and the other side in the third direction Z refers to a lower direction on a cross-sectional view. However, it should be understood that the direction mentioned in the embodiments means a relative direction, and the embodiments are not limited to the mentioned direction.

The display device 1 may include various electronic devices that provide a display screen. Examples of the display device 1 may include, but are not limited to, a mobile phone, a smart phone, a tablet personal computer (PC), a mobile communication terminal, an electronic diary, an electronic book, a personal digital assistant (PDA), a portable multimedia player (PMP), a navigator, an ultra mobile PC (UMPC), a television, a game machine, a wristwatch-type electronic device, a head mounted display, a monitor of a personal computer, a laptop computer, a car instrument panel, a digital camera, a camcorder, an outdoor billboard, an electronic signboard, various medical devices, various inspection devices, various home appliances including a display area such as a refrigerator or a washing machine, and an Internet of Things device.

Referring to FIG. 1, at least one of a front surface or a rear surface of the display device 1 may be a display surface. In this case, the “front surface” refers to a surface located at one side of one plane in the third direction Z on the drawing, and the “rear surface” refers to a surface located at the other side of one plane in the third direction Z on the drawing.

According to some embodiments, the display surface may be located on the front surface of the display device 1, and no display may be made on the rear surface. Although the following description will be based on such embodiments, the display device 1 may be a double-sided display device 1 in which display is made on both the front and rear surfaces.

The display device 1 may include a display panel 10 for providing a display screen, a display driving circuit 30 (or a display driving chip) and a scan driver 50, which are located in a non-display area NDA of the display panel 10, and a circuit board SUB located in the non-display area NDA of the display panel 10.

Examples of the display panel 10 may include a light receiving display panel 10 such as a liquid crystal display (LCD) panel and an electrophoretic display (EPD) panel as well as a self-light emitting display panel 10 such as an organic light emitting display (OLED) panel, an inorganic light emitting display panel, a quantum dot light emitting display (QED) panel, a micro LED panel, a nano LED panel, a plasma display panel, a field emission display panel and a cathode-ray (CRT) display panel. Hereinafter, the organic light emitting display panel 10 will be described as the display panel 10 by way of example, and the organic light emitting display panel 10 applied to the embodiments will be simply abbreviated as the display panel 10 unless a special distinction is required. However, the embodiments are not limited to the organic light emitting display panel 10, and other display panels 10 listed above or known in the art may be applied within the range that shares the technical spirits.

The display panel 10 may have a rectangular shape having a short side in the first direction X and a long side in the second direction Y on a plane. A corner at which the short side in the first direction X meets the long side in the second direction Y may be rounded to have a curvature or formed at a right angle.

However, the planar shape of the display panel 10 is not limited to the above example, and may have various planar shapes such as other polygonal shape, a circular shape or an oval shape. Also, the display panel 10 may be flexibly formed to be curved, twisted, bent, folded, or rolled.

The display panel 10 may include a display layer for displaying a screen.

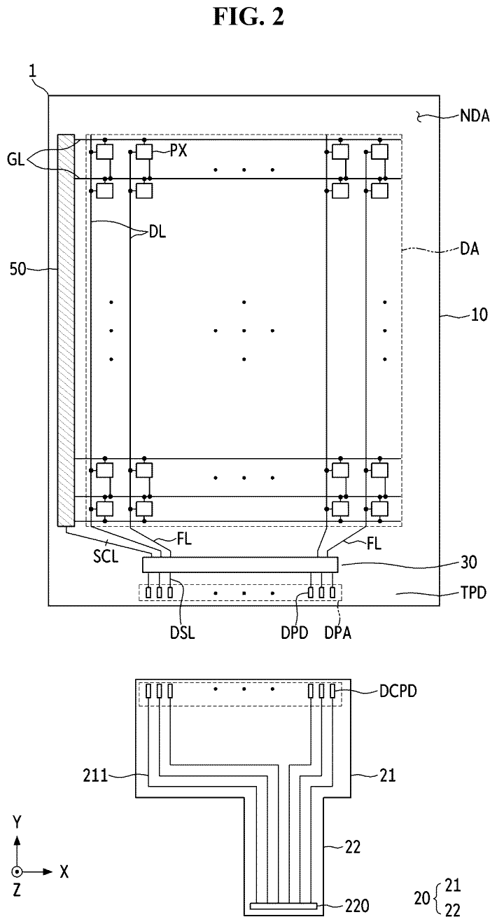

The display layer may include a plurality of pixels (e.g., PX of FIG. 2). The pixel PX may be a basic unit for displaying a screen. The pixel PX may include, but is not limited to, a red pixel, a green pixel, and a blue pixel. The plurality of pixels PX may be arranged in a matrix configuration, but embodiments according to the present disclosure are not limited thereto.

The display panel 10 may include a display area DA and a non-display area NDA. A portion for displaying the screen is defined as the display area DA, and a portion for not displaying the screen is defined as the non-display area NDA.

The illustrated shape of the display area DA is a rectangular shape in which the second direction Y is longer than the first direction X, but is not limited thereto. The display area DA may have a rectangular shape in which corners are rounded and the first direction X is longer than the second direction Y, or may have various shapes such as a square shape, other polygonal shape, a circular shape, or an oval shape.

The non-display area NDA is located in the vicinity (e.g., in a periphery or outside a footprint) of the display area DA. The non-display area NDA may be a bezel area. The non-display area NDA may surround all sides of the display area DA, but is not limited thereto. For example, the non-display area NDA may be located only in the vicinity of three sides of the display area DA. In this case, the remaining one side of the display area DA may form an edge of the display device 1.

Signal lines or driving circuits for applying signals to the display area DA may be located in the non-display area NDA. The non-display area NDA may not include the display area DA.

The display driving circuit 30 may be located in the non-display area NDA below the display panel 10. The display driving circuit 30 may be formed of an integrated circuit (IC) and attached to the non-display area NDA below the display panel 10 in a chip on glass (COG) manner, a chip on plastic (COP) manner, or an ultrasonic bonding manner, but is not limited thereto. For example, the display driving circuit 30 may be attached onto the circuit board SUB.

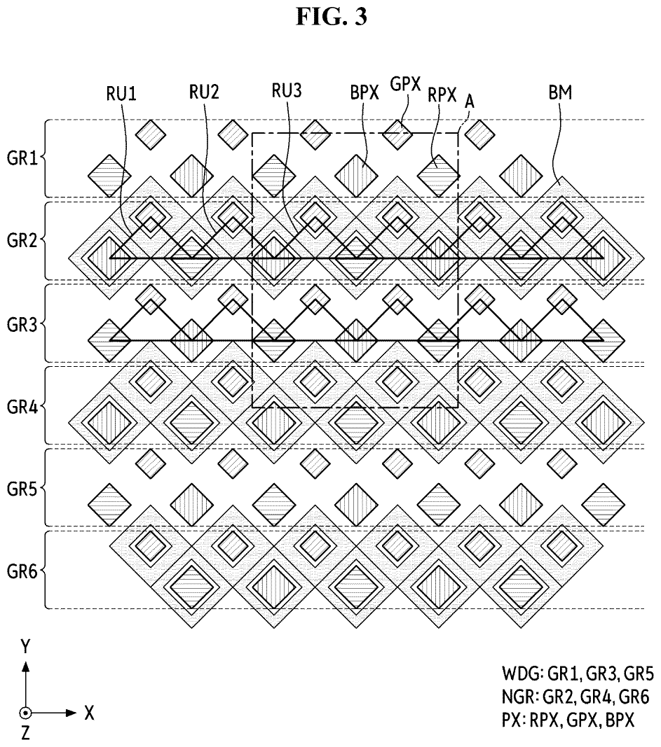

According to some embodiments, the display driving circuit 30 may generate signals for driving the plurality of pixels PX of the display panel 10 by receiving a clock voltage, a data voltage and the like from a main processor of a main circuit board through a plurality of conductive lines (e.g., 211 of FIG. 2 and 212 of FIG. 3) of the circuit board SUB.

The circuit board SUB may be located in the non-display area NDA of a lower end of the display panel 10. The circuit board SUB may be attached onto a pad area DPA (e.g., DPA of FIG. 2) located in the non-display area NDA of the lower end of the display panel 10 through a connection member that will be described later. The circuit board SUB may include a plurality of conductive lines 211 for transferring signals from the main circuit board to the display driving circuit 30. Hereinafter, the circuit board SUB is a flexible circuit board SUB containing a flexible material, but is not limited thereto, and the circuit board SUB may be a rigid circuit board SUB.

FIG. 2 is a schematic plan view illustrating an arrangement structure of a plurality of data lines and a plurality of conductive lines of a circuit board according to some embodiments.

For convenience of description, FIG. 2 briefly shows a plurality of pixels PX, a plurality of gate lines GL, a plurality of data lines DL and the like of the display layer. Furthermore, FIG. 2 shows a plurality of conductive lines 211 electrically connected to the display driving circuit 30 through the display pad area DPA among the plurality of conductive lines 211 of the circuit board SUB.

The display panel 10 may include a display layer as described above.

Referring to FIG. 2, the display layer may include a plurality of pixels PX, and a plurality of gate and data lines GL and DL respectively connected to the plurality of pixels PX.

Each of the plurality of pixels PX may include a light emitting element EL for displaying a screen and a plurality of thin film transistors TFT for driving the light emitting element EL. The plurality of thin film transistors TFT may include a driving transistor that controls a current flowing to the light emitting element EL and a switch transistor that serves as a switch element. Each of the plurality of pixels PX may be connected to at least one of the plurality of gate lines GL or any one of the plurality of data lines DL.

The plurality of gate lines GL may be extended from the scan driver 50 located in the non-display area NDA of one side of the display panel 10 in the first direction X. The scan driver 50 may receive a scan control signal from the display driving circuit 30 through a scan control line SCL, and thus generate a scan signal to apply the scan signal to the plurality of gate lines GL. The plurality of gate lines GL may transfer the scan signal applied from the scan driver 50 to the plurality of pixels PX, respectively. The scan driver 50 may control turn-on or turn-off of the switch transistor through the plurality of gate lines GL.

The plurality of data lines DL may be extended in the second direction Y. The plurality of data lines DL may be connected to the display driving circuit 30 through fan-out lines FL. Data signals generated in the display driving circuit 30 may be applied to each of the data lines DL. The display driving circuit 30 may control the amount of light emitted from the light emitting element EL through the plurality of data lines DL. That is, the data signals of the plurality of data lines DL may be applied to a gate electrode of the driving transistor to control the magnitude of the current flowing to the light emitting element EL.

Referring to FIG. 2, the pad area DPA may be located in the non-display area NDA of the lower end of the display panel 10. The pad area DPA may be electrically connected to the circuit board SUB through the connection member.

The pad area DPA may include display pads DPD connected to the display driving circuit 30 through a plurality of display signal lines DSL. The plurality of display signal lines DSL may include a plurality of data voltage lines for generating a plurality of data signals in the display driving circuit 30, a ground connection line, and a clock voltage line for generating a scan control signal.

The circuit board SUB may include a body portion 21 and a tail portion 22.

The tail portion 22 of the circuit board SUB may be connected to the main circuit board, but is not limited thereto. For example, the circuit board SUB includes the body portion 21, but may be also connected to the main circuit board through a separate cable.

The body portion 21 may have a rectangular shape in which a width in the first direction X is greater than a width in the second direction Y on a plane. The width of the body portion 21 in the first direction X may be smaller than the width of the display panel 10 in the first direction X. The tail portion 22 may have a shape protruded from a lower end of the body portion 21. The tail portion 22 may have a rectangular shape in which a width in the second direction Y is greater than a width in the first direction X. The width of the tail portion 22 in the first direction X may be smaller than the width of the body portion 21 in the first direction X. However, the embodiments are not limited to the above examples. For example, each of the body portion 21 and the tail portion 22 of the circuit board SUB may have a shape in which one side is introduced or protruded inward, or may include a hole in at least a partial area. In this way, various modifications may be made in the shape of the circuit board SUB.

The circuit board SUB may include a plurality of connection pads DCPD for being electrically connected to the display pads DPD of the display panel 10, respectively, and a plurality of conductive lines 211. The plurality of connection pads DCPD may be connected to the pads DPD of the display panel 10.

The circuit board SUB may include a coupling member located at a lower end of the tail portion 22. The coupling member may be, but not limited to, a connector for being connected to the main circuit board.

Some of the plurality of conductive lines 211 may be extended from the body portion 21 in a direction opposite to the second direction Y as shown in FIG. 2 and then extended in the first direction X, and again may be extended in the direction opposite to the second direction Y and then located on the tail portion 22. Therefore, the plurality of first conductive lines 211 may be electrically connected to the main circuit board through the coupling member.

However, the extended direction of the plurality of conductive lines 211 shown in FIG. 2 is briefly shown for convenience of description, the embodiments are not limited thereto, and various modifications may be made in the extended direction of the plurality of conductive lines 211.

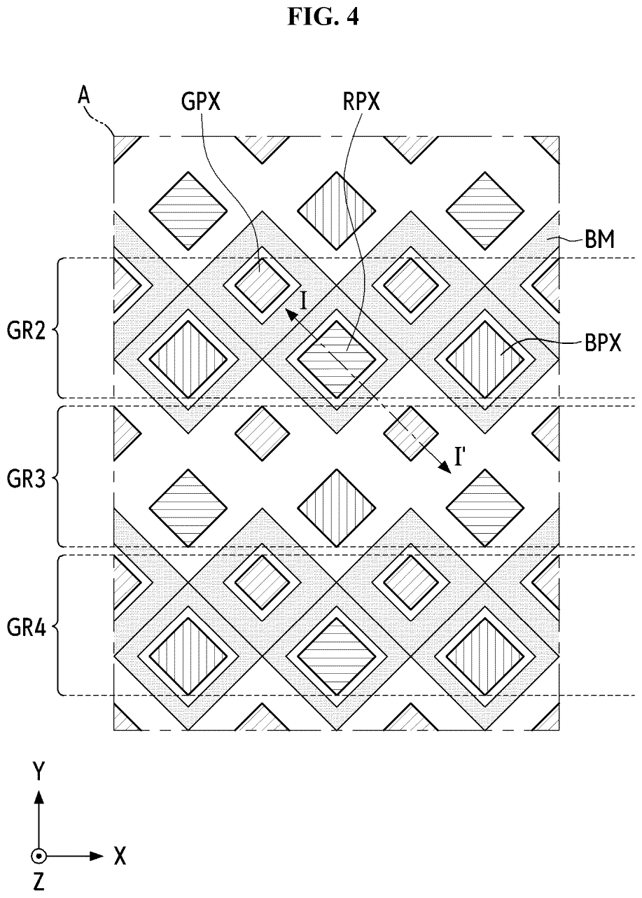

FIG. 3 is a plan view illustrating an arrangement of pixels and a light blocking layer of a display device according to some embodiments, and FIG. 4 is an enlarged view illustrating an area A of FIG. 3.

Referring to FIGS. 3 and 4, a red pixel RPX for providing red light, a green pixel GPX for providing green light and a blue pixel BPX for providing blue light may be located in the display area DA of the display panel 10 of the display device 1 according to some embodiments. The red pixel RPX, the green pixel GPX and the blue pixel BPX that are adjacent to one another may form one unit pixel.

For example, the red pixel RPX and the blue pixel BPX may be located in the same row and the same column of the display panel 10, and the red pixel RPX and the blue pixel BPX may be alternately arranged in any one row and column. The green pixel GPX may be located in different rows and columns of the display panel 10 from the red pixel RPX and the blue pixel BPX. For example, the plurality of pixels PX may have a pentile array. However, the array type of the pixels PX is exemplary and is not limited thereto.

The blue pixel BPX, the green pixel GPX and the red pixel RPX, which are arranged to be adjacent to one another, may form one rendering unit. Three pixels PX included in one rendering unit may be implemented together in a process of implementing one color. For example, the blue pixel BPX, the green pixel GPX and the red pixel RPX, which are included in a first rendering unit RU1, may be driven together. When the first rendering unit RU1 emits white light, the blue pixel BPX, the green pixel GPX and the red pixel RPX, which are included in the first rendering unit RU1, may provide blue light, green light, and red light with the same intensity. As a result, a user may visually recognize three kinds of light by three pixels PX from the outside of the display device 1 as white light.

The display panel 10 may include a plurality of rendering units. The rendering units arranged to be adjacent to each other in the first direction X may share one pixel PX. For example, as shown in FIG. 3, the first rendering unit RU1 and a second rendering unit RU2, which are adjacent to each other along the first direction X, may share the red pixel RPX with each other, and the second rendering unit RU2 and a third rendering unit RU3, which are adjacent to each other along the first direction X, may share the blue pixel BPX with each other. A group of rendering units, such as the first rendering unit RU1, the second rendering unit RU2 and the third rendering unit RU3, which are arranged to be adjacent to one another, consecutively sharing pixels, is defined as a rendering group.

The light blocking layer BM may be arranged for each rendering group. For example, the light blocking layer may be located near the pixels of the even-numbered rendering group, and is not located near the pixels of the odd-numbered rendering group. As a detailed example, from a plan view, the pixels of the even-numbered rendering group may be surrounded by the light blocking layer BM. In other words, as shown in FIGS. 3 and 4, all of the pixels of the even-numbered rendering group (e.g., GR2) may be surrounded by one light blocking layer BM, but are not limited thereto. For example, the pixels of the even-numbered rendering group (e.g., GR2) may be individually surrounded by a plurality of light blocking layers. In this case, the plurality of light blocking layers may be separated from each other without being connected to each other. For example, the plurality of light blocking layers may be arranged to be spaced apart from each other.

Hereinafter, a rendering group including pixels surrounded by the light blocking layer BM is defined as a narrow rendering group, and a rendering group including pixels that are not surrounded by the light blocking layer BM is defined as a wide rendering group. The narrow rendering group NRG and the wide rendering group WDG may be alternately arranged in the second direction Y.

In FIG. 3, six rendering groups GR1, GR2, GR3, GR4, GR5 and GR6 are shown by way of example, and the wide rendering groups WDG and the narrow rendering groups NRG may be alternately arranged along the second direction Y. For example, the odd-numbered rendering groups (e.g., the first rendering group GR1, the third rendering group GR3 and the fifth rendering group GR5) of the six rendering groups GR1, GR2, GR3, GR4, GR5 and GR6 may be the wide rendering groups WDG, and the even-numbered rendering groups (e.g., the second rendering group GR2, the fourth rendering group GR4 and the sixth rendering group GR6) may be the narrow rendering groups NRG. However, depending on the arrangement position of the light blocking layer BM, the odd-numbered rendering group may be a narrow rendering group NRG, and the even-numbered rendering group may be a wide rendering group WDG.

The pixels PX of the narrow rendering group NRG may provide low luminance light, while the pixels PX of the wide rendering group WDG may provide high luminance light. In other words, the pixels PX of the narrow rendering group NRG may provide light having lower luminance than the pixels PX of the wide rendering group WDG. This is because the pixels PX of the narrow rendering group NRG are surrounded by the light blocking layer BM. For example, light from the pixels PX of the narrow rendering group NRG is partially blocked by the light blocking layer BM, whereas light from the wide rendering pixels is not blocked by the light blocking layer BM. Therefore, the pixels PX of the narrow rendering group NRG may have a viewing angle narrower than that of the pixels PX of the wide rendering group WDG.

Each of the narrow rendering group NRG and the wide rendering group WDG may include a plurality of green pixels GPX, a plurality of red pixels RPX, and a plurality of blue pixels BPX. The plurality of pixels may have different sizes. For example, the green pixel GPX may be smaller than the red pixel RPX and the blue pixel BPX, and the sizes of the red pixel RPX and the blue pixel BPX may be substantially the same as each other, but the present disclosure is not limited thereto. In this case, the size of each pixel PX may substantially mean a size of a light emission area of the corresponding pixel PX (e.g., an area of a light emission area in a plan view).

In addition, each of the green pixel GPX, the red pixel RPX and the blue pixel BPX may have a rectangular planar shape such as a rhombus, but is not limited thereto, and may have an octagonal shape or other polygonal planar shape, or a circular or oval shape. In this case, the shape of each pixel may substantially mean the shape of the light emission area of the corresponding pixel (e.g., the shape of the light emission area from a plan view).

The display device 1 according to some embodiments may operate in a first mode (or a normal mode) and a second mode (or a private mode). When the display device operates in the first mode, the pixels PX of the narrow rendering groups NRG and the pixels PX of the wide rendering group WDG may all emit light. When the display device 1 operates in the second mode, the pixels PX of the narrow rendering group NRG may emit light, while the pixels PX of the wide rendering group WDG may not emit light. For example, in the second mode, only the pixels PX of the narrow rendering groups NRG among the narrow rendering groups NRG and the wide rendering groups WDG may provide light.

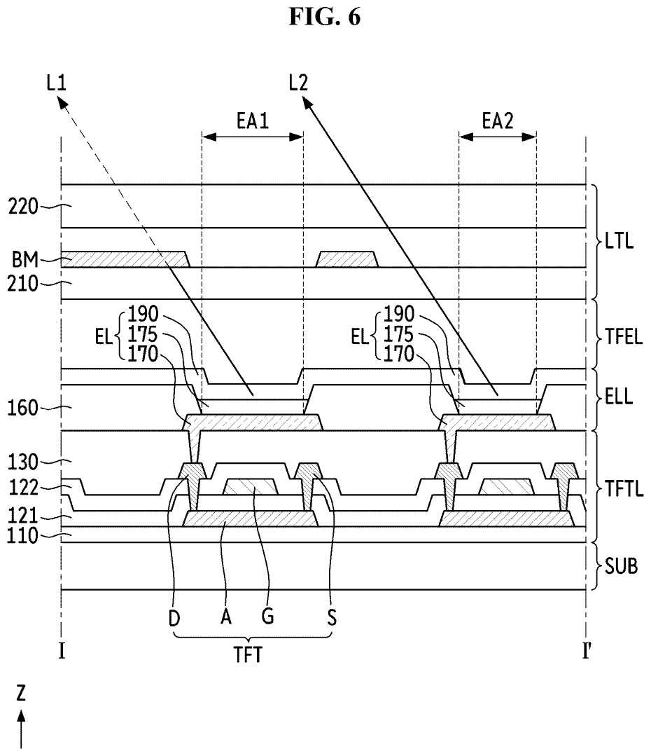

In an environment having a wide viewing angle, as described later in FIG. 6, because light provided from the pixels PX of the narrow rendering group NRG may be blocked by the light blocking layer BM, the amount of light visually recognized from the outside of the display device 1 may be small. Therefore, when the display device 1 is driven in the first mode, light from the pixels PX of the narrow rendering group NRG is blocked in an environment having a wide viewing angle, while light from the pixels PX of the wide rendering group WDG is not blocked, so that the display device 1 may provide light having a high luminance ratio.

Meanwhile, when the display device 1 is driven in the second mode, light from the pixels PX of the narrow rendering group NRG is blocked in an environment having a wide viewing angle, and the pixels PX of the wide rendering group WDG are turned off, so that the display device 1 may provide light having a relatively low luminance ratio. In other words, when the display device 1 is driven in the second mode, a luminance ratio of a large difference may be implemented depending on a viewing angle. Accordingly, light of sufficient luminance is provided to a user who gazes at the display device 1 at a narrow viewing angle, whereas light of relatively low luminance is provided to a user (e.g., another person) who gazes at the display device at a wide viewing angle, whereby the risk of exposure of a user's personal information may be minimized.

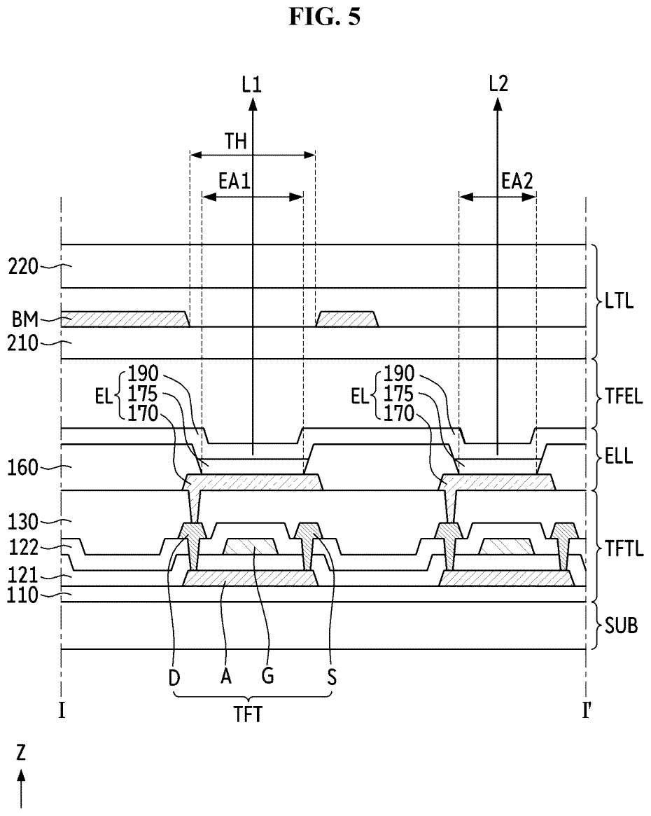

FIG. 5 is a cross-sectional view taken along the line I-I′ of FIG. 4.

Referring to FIG. 5, the display device 1 may include a substrate SUB, a thin film transistor layer TFT, a light emitting element layer ELL, an encapsulation layer TFTL, and a light transmitting layer LTL, which are located on the substrate SUB.

The substrate SUB may be a rigid substrate, or may be a flexible substrate SUB capable of being subjected to bending, folding, rolling or the like. The substrate SUB may be made of an insulating material such as glass, quartz and a polymer resin.

A buffer film 110 may be located on one surface of the substrate SUB. The buffer film 110 may include silicon nitride, silicon oxide, or silicon oxynitride.

The thin film transistor layer TFT may be located on the buffer film 110. The thin film transistor layer TFT may include a semiconductor layer A, a gate insulating layer 121 located on a portion of the semiconductor layer A, a gate electrode on the gate insulating layer 121, an interlayer insulating layer 122 covering the semiconductor layer A and the gate electrode, and a source electrode S and a drain electrode D on the interlayer insulating layer 122.

The semiconductor layer A may form a channel. The semiconductor layer A may include polycrystalline silicon. According to some embodiments, the semiconductor layer A may include single crystal silicon, low-temperature polycrystalline silicon, amorphous silicon, or an oxide semiconductor. The oxide semiconductor may include a binary compound (ABx), a ternary compound (ABxCy) and a tetragonal compound (ABxCyDz), which contain, for example, indium, zinc, gallium, tin, titanium, aluminum, hafnium (Hf), zirconium (Zr) and magnesium (Mg). Each of the semiconductor layers A may include a channel area, and source and drain areas doped with impurities.

The gate insulating layer 121 is located on the semiconductor layer A. The gate insulating layer 121 electrically insulates the gate electrode G from the semiconductor layer A. The gate insulating layer 121 may be made of an insulating material, for example, silicon oxide (SiOx), silicon nitride (SiNx), or metal oxide.

A gate electrode G is located on the gate insulating layer 121. The gate electrode G may be formed above the channel area of the semiconductor layer A, that is, at a position that overlaps the channel area on the gate insulating layer 121.

The interlayer insulating layer 122 may be located on the gate electrode G. The interlayer insulating layer 122 may include an inorganic insulating material such as silicon oxide (SiOx), silicon nitride (SiNx), silicon oxynitride, hafnium oxide and aluminum oxide.

The source electrode S and the drain electrode D are located on the interlayer insulating layer 122. The source electrode S may be electrically connected to the drain electrode D of the semiconductor layer A through a contact hole that passes through the interlayer insulating layer 122 and the gate insulating layer 121. The source electrode S and the drain electrode D may include at least one metal selected from aluminum (Al), molybdenum (Mo), platinum (Pt), palladium (Pd), silver (Ag), magnesium (Mg), gold (Au), nickel (Ni), neodymium (Nd), iridium (Ir), chrome (Cr), calcium (Ca), titanium (Ti), tantalum (Ta), tungsten (W) and copper (Cu).

A planarization layer 130 may be formed on the interlayer insulating layer 122 to cover the source electrode S and the drain electrode D. The planarization layer 130 may be formed of an organic insulating material or the like. The planarization layer 130 may have a flat surface, and may include a contact hole for exposing any one of the source electrode S and the drain electrode D.

The light emitting element layer ELL may be located on the planarization layer 130. The light emitting element layer ELL may include a light emitting element EL and a pixel defining layer 160. The light emitting element EL may include a pixel electrode 170, a light emitting layer 175, and a common electrode 190.

The pixel electrode 170 of the light emitting element EL may be located on the planarization layer 130. The pixel electrode 170 may be provided for each pixel. The pixel electrode 170 may be connected to the source electrode S or the drain electrode D of the thin film transistor layer TFT through a contact hole that passes through the planarization layer 130.

The pixel electrode 170 may have a single layered structure of molybdenum (Mo), titanium (Ti), copper (Cu) or aluminum (Al), or may have a stacked layer structure of, for example, indium-tin-oxide (ITO), indium-zinc-oxide (IZO), zinc oxide (ZnO), indium oxide (In₂O₃), and a multi-layered structure of ITO/Mg, ITO/MgF, ITO/Ag, and ITO/Ag/ITO, which contain silver (Ag), magnesium (Mg), aluminum (Al), platinum (Pt), lead (Pb), gold (Au) and nickel (Ni).

The pixel defining layer 160 may be located on the pixel electrode 170. The pixel defining layer 160 may be formed in an area that overlaps the pixel electrode 170 to form an opening for exposing the pixel electrode 170. Areas where the exposed pixel electrode 170 and the light emitting layer 175 overlap each other may be defined as a first light emission area EA1 and a second light emission area EA2 of each pixel.

The pixel defining layer 160 may include an organic insulating material such as a polyacrylates resin, an epoxy resin, a phenolic resin, a polyamides resin, a polyimides resin, an unsaturated polyesters resin, a poly phenylenethers resin, a polyphenylenesulfides resin, or a benzocyclobutene (BCB). As another example, the pixel defining layer 160 may include an inorganic material such as silicon nitride.

The light emitting layer 175 may be located on the pixel electrode 170 exposed by the opening of the pixel defining layer 160. The light emitting layer 175 may include a high molecular material or a low molecular material, and may emit red, green or blue light for each pixel PX. Light emitted from the light emitting layer 175 may contribute to image display.

When the light emitting layer 175 is formed of an organic material, a hole injecting layer HIL and a hole transporting layer HTL may be located in a lower portion of each light emitting layer 175, and an electron injecting layer EIL and an electron transporting layer ETL may be stacked in an upper portion thereof. These layers may be a single layer or multiple layers of an organic material.

The common electrode 190 may be located on the light emitting layer 175 and the pixel defining layer 160. The common electrode 190 may be arranged over the entire pixels to cover the light emitting layer 175 and the pixel defining layer 160. The common electrode 190 may include a conductive material having a low work function, for example, Li, Ca, LiF/Ca, LiF/Al, Al, Mg, Ag, Pt, Pd, Ni, Au Nd, Ir, Cr, BaF, Ba or their compound or mixture (for example, a mixture of Ag and Mg). Alternatively, the common electrode 190 may include a transparent metal oxide, for example, indium-tin-oxide (ITO), indium-zinc-oxide (IZO) or zinc oxide (ZnO).

An encapsulation layer TFEL may be located on the light emitting element layer EEL. The encapsulation layer TFEL may include at least one inorganic layer and one organic layer to prevent or reduce instances of contaminants such as oxygen or moisture being permeated into the light emitting layer 175 or protect the light emitting layer 75 from particles such as dust. For example, the encapsulation layer TFL may be formed in a structure in which a first inorganic layer, an organic layer, and a second inorganic layer are sequentially stacked. The first inorganic layer and the second inorganic layer may be formed of a multi-layer in which one or more inorganic layers of a silicon nitride layer, a silicon oxynitride layer, a silicon oxide layer, a titanium oxide layer and an aluminum oxide layer are alternately stacked. The organic layer may be an organic layer such as an acrylic resin, an epoxy resin, a phenolic resin, a polyamide resin and a polyimide resin.

The light transmitting layer LTL may be located on the encapsulation layer TFEL. The light transmitting layer LTL may include a transparent inorganic layer 210, a light blocking layer BM and a transparent organic layer 220, which are sequentially located on the encapsulation layer TFEL.

The transparent inorganic layer 210 may include an inorganic insulating material that transmits light. The transparent inorganic layer 210 may include a silicon nitride layer, a silicon oxynitride layer, a silicon oxide layer, a titanium oxide layer, or an aluminum oxide layer.

A material that blocks light emission from the light emitting element EL may be used as the light blocking layer BM located on the transparent inorganic layer 210. The light blocking layer BM may include an organic light blocking material using a resin material containing a pigment (such as carbon black) or a dye. Therefore, the light blocking layer BM may block light emitted from the light emission area at a wide viewing angle, and may prevent or reduce instances of color mixture occurring due to light permeation between adjacent light emission areas EA.

The light blocking layer BM may include transmissive holes TH that overlap the first light emission areas EA1. The transmissive hole TH may overlap the first light emission area EA1 in the third direction Z. A width of the transmissive hole TH may be greater than a width of the first light emission area EA1, but is not limited thereto. For example, the width of the transmissive hole TH may be the same as the width of the first light emission area EA1. The transmissive hole TH may not overlap the pixel defining layer 160 in the third direction Z. An end of the light blocking layer BM may overlap an end of the pixel defining layer 160 in the third direction Z.

When viewed in a plan view, the light emission area (e.g., EA1) of the pixel PX included in the narrow rendering group NRG may be surrounded by the light blocking layer BM (e.g., the transmissive hole TH of the light blocking layer). Meanwhile, when viewed in a plan view, the light emission area (e.g., EA2) of the pixel PX included in the wide rendering group WDG may not be surrounded by the light blocking layer BM (e.g., the transmissive hole TH of the light blocking layer).

The transparent organic layer 220 located on the light blocking layer BM may include an organic material that transmits light. The transparent organic layer 220 may be an organic layer such as an acrylic resin, an epoxy resin, a phenolic resin, a polyamide resin, or a polyimide resin.

The light blocking layer BM that partitions the transmissive hole TH may be arranged to surround the first light emission area EA1. Therefore, the end of the pixel defining layer that partitions the light emission areas EA1 and EA2 may overlap the end of the light blocking layer BM in the third direction Z

Because the transmissive hole TH overlaps the first light emission area EA1 in the third direction Z when the viewing angle is 0° to 30°, light L1 from the light emitting layer 175 (hereinafter, referred to as a first light emitting layer) that overlaps the first light emission area EA1 may be emitted to the outside of the display device 1 and visually recognized from the outside, and because the light blocking layer BM is not located near the light emitting layer 175 (hereinafter, referred to as a second light emitting layer) that overlaps the second light emission area EA2, light L2 from the second light emitting layer may be also emitted to the outside of the display device 1 and visually recognized from the outside.

FIG. 6 is a cross-sectional view illustrating a moving path of light in FIG. 5 in an environment having a wide viewing angle.

Referring to FIG. 6, when the viewing angle is wide, the light L1 from the first light emitting layer may not be visually recognized from the outside or may represent low luminance, but the light L2 from the second light emitting layer may be visually recognized from the outside. In more detail, the light blocking layer BM may be located in the vicinity of the first light emission area EA1, and accordingly, in an environment having a wide viewing angle, a user of the display device 1 may view the display device 1 in a direction spaced apart from the side rather than a position that overlaps the first light emission area EA1 in the third direction Z. Therefore, the light blocking layer BM is located between the user's eyes and the first light emission area EA1, and the light from the first light emission area EA1 is blocked by the light blocking layer BM so that the light is not visually recognized by the user, or only a small amount of reflected and/or diffracted light may be visually recognized by the user. On the other hand, the light blocking layer BM may not be located in the vicinity of the second light emission area EA2. As a result, even in an environment having a wide viewing angle, the light blocking layer BM is not located between the user's eyes and the second light emission area EA2, whereby the light from the second light emission area EA2 may be visually recognized by the user without being blocked.

The first light emission area EA1 may be included in the pixel PX of the narrow rendering group NRG, and the second light emission area EA2 may be included in the pixel PX of the narrow rendering group NDG. For example, in an environment having a wide viewing angle, light from pixels PX of the narrow rendering group NRG is blocked by the light blocking layer BM and thus has low luminance, and light from pixels PX of the wide rendering group WDG is not blocked by the light blocking layer BM and thus may have sufficient luminance.

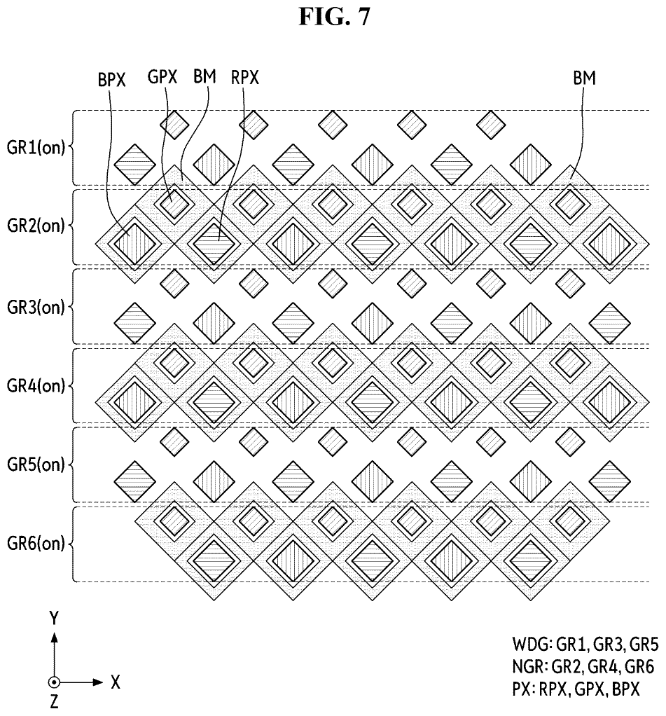

FIG. 7 is a view illustrating an operation of pixels when a display device according to some embodiments is driven in a first mode.

Referring to FIG. 7, when the display device 1 is driven in the first mode, all of the pixels PX included in the display device 1 may be turned on. For example, all of the pixels of the narrow rendering group NRG and the pixels PX of the wide rendering group WDG may emit light. According to some embodiments, each of the pixels PX of the second rendering group GR2, the fourth rendering group GR4 and the sixth rendering group GR6, which correspond to the narrow rendering group NRG, may emit light.

When the display device 1 emits white light over the entire display area DA, all of the pixels PX of the display device 1 may provide light having the same luminance. Light (e.g., red light) from the red pixel RPX, light (e.g., green light) from the green pixel GPX and light (e.g., blue light) from the blue pixel BPX, which are included in one rendering group, may be mixed with one another and recognized as white light.

In an environment having a narrow viewing angle, both light from the pixels PX of the narrow rendering group NRG and light from the pixels PX of the wide rendering group WDG may be visually recognized without being blocked by the light blocking layer BM. Therefore, the user may recognize that white light is emitted from all portions of the display area DA of the display device 1.

In an environment having a wide viewing angle, all light from the pixels PX of the wide rendering group WDG may be still visually recognized. Light from the pixels PX of the narrow rendering group NRG is blocked by the light blocking layer BM, so that only a portion of the light may be visually recognized from the outside. In this process, light from the red pixel RPX, light from the blue pixel BPX and light from the green pixel GPX, which form the same rendering unit, may be blocked together. Therefore, a ratio of red light, blue light and green light, which are provided from the pixels PX of the narrow rendering group NRG, among the light recognized from the outside may be the same as a ratio of red light, blue light and green light, which are provided from the pixels PX of the wide rendering group WDG.

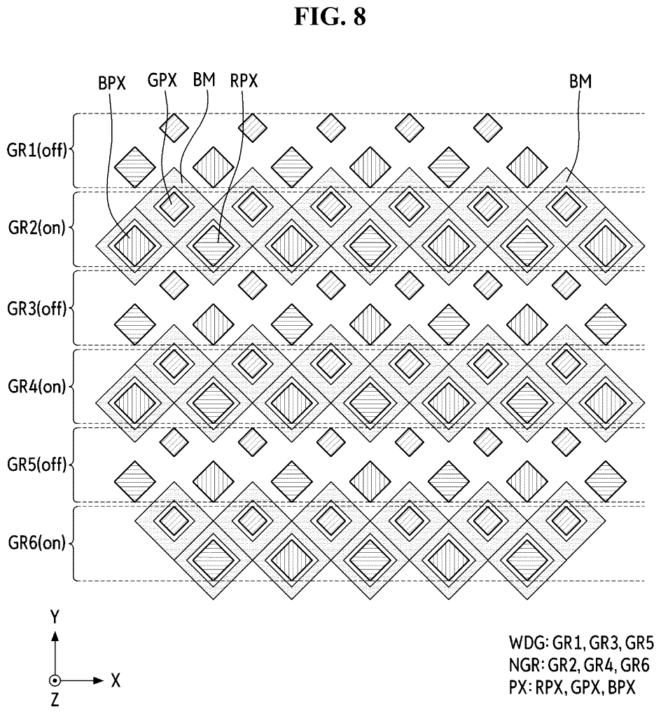

FIG. 8 is a view illustrating an operation of pixels when a display device according to some embodiments is driven in a second mode.

Referring to FIG. 8, when the display device 1 is driven in the second mode, pixels PX of the narrow rendering group NRG among the pixels included in the display device 1 may be turned on (e.g., emit light), and pixels PX of the wide rendering group WDG may be turned off (e.g., non-emit light). According to some embodiments, the pixels PX of the second rendering group GR2, the fourth rendering group GR4 and the sixth rendering group GR6, which correspond to the narrow rendering group NRG, are all turned on, whereas the pixels PX of the first rendering group GR1, the third rendering group GR3 and the fifth rendering group GR5, which correspond to the wide rendering group WDG, may be all turned off.

When the display device 1 emits white light, the pixels PX of the narrow rendering group NRG may provide light having the same luminance, and the pixels PX of the wide rendering group WDG may not provide light. Light from the red pixel RPX, light from the green pixel GPX and light from the blue pixel BPX, which are included in one rendering unit of the pixels of the narrow rendering group NRG, may be mixed with one another and recognized as white light.

In an environment having a narrow viewing angle, the light from the pixels PX of the narrow rendering group NRG may be visually recognized without being blocked by the light blocking layer BM. Therefore, the user may recognize that white light is emitted from all portions of the display area DA of the display device 1.

In an environment having a wide viewing angle, the light from the pixels PX of the narrow rendering group NRG may be blocked by the light blocking layer BM, so that only a portion of the light may be visually recognized from the outside. In this process, light from the red pixel RPX, light from the blue pixel BPX and light from the green pixel GPX, which form the same rendering unit, may be blocked together.

Meanwhile, when the display device displays an image corresponding to full white in the second mode, a data signal of the highest gray scale (e.g., a data voltage of a full white gray scale) may be applied to the pixels PX of the narrow rendering group NRG, and a data signal of the lowest gray scale (e.g., a data voltage of a full black gray scale) may be applied to the pixels PX of the wide rendering group WDG.

In this way, in the second mode, because the data signal applied to the pixels PX of the narrow rendering group NRG and the data signal applied to the pixels PX of the wide rendering group WDG have a large difference from each other, the data signals applied to the data line DL may be changed from the highest gray scale value to the lowest gray scale value and from the lowest gray scale value to the highest gray scale value for each period. In other words, when the display device 1 is driven in the second mode, a swing width of the data signal of the data line DL is increased to a maximum value. Therefore, a problem may occur in that power consumption of the display device 1 is increased in the second mode.

According to some embodiments, because a full white image may be displayed in the second mode without change in the gray scale of data signals applied to the data line DL, the display device according to some embodiments will be described in more detail as follows.

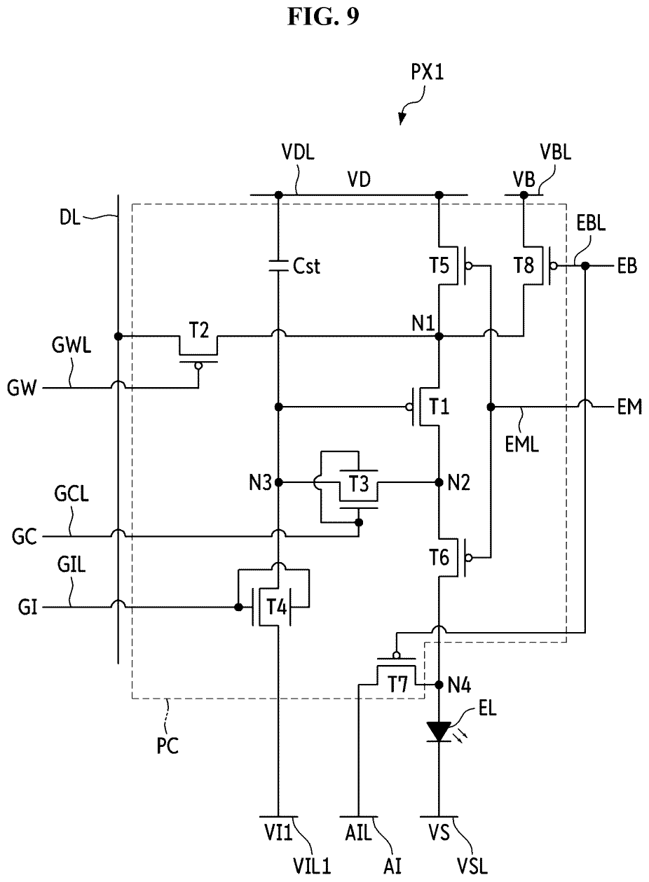

FIG. 9 is a view illustrating an equivalent circuit of pixels included in a wide rendering group WDG. For example, FIG. 9 may be an equivalent circuit of any one pixel (e.g., a first pixel PX1) included in the wide rendering group WDG of FIG. 3. Although FIG. 9 illustrates various components in a pixel according to some embodiments, embodiments according to the present disclosure are not limited thereto, and according to some embodiments, the pixel may include additional components or fewer components without departing from the spirit and scope of embodiments according to the present disclosure.

As shown in FIG. 9, the first pixel PX1 may be connected to a first gate line GWL, a second gate line GCL, a third gate line GIL, a fourth gate line EBL, an emission control line EML, a data line DL, a driving voltage line VDDL, a common voltage line VSL, a first initialization voltage line VIL1, an anode initialization voltage line AIL, and a bias voltage line VBL.

The pixel PX may include a pixel circuit PC and a light emitting element EL. The pixel circuit PC may include a first transistor T1, a second transistor T2, a third transistor T3, a fourth transistor T4, a fifth transistor T5, a sixth transistor T6, a seventh transistor T7, an eighth transistor T8, and a capacitor Cst.

The first transistor T1 may include a gate electrode, a source electrode, and a drain electrode. The first transistor T1 may control a source-drain current (hereinafter, a driving current) in accordance with a data voltage applied to the gate electrode. A driving current (e.g., Isd) flowing through a channel area of the first transistor T1 may be proportional to a square of a difference between a voltage Vsg between the source electrode and the gate electrode of the first transistor T1 and a threshold voltage Vth (Isd=k×(Vsg−Vth)²). In this case, k denotes a proportional coefficient determined by a structure and physical characteristics of the first transistor T1, Vsg denotes a source-gate voltage of the first transistor T1, and Vth denotes the threshold voltage of the first transistor T1.

The light emitting element EL may emit light by receiving the driving current Isd. The light emitting amount or luminance of the light emitting element EL may be proportional to a magnitude of the driving current Isd.

The light emitting element EL may be an organic light emitting diode that includes a first electrode (e.g., the pixel electrode 170), a second electrode (e.g., the common electrode 190), and an organic light emitting layer (e.g., 175) located between the first electrode and the second electrode. As another example, the light emitting element EL may be an inorganic light emitting element that includes a first electrode, a second electrode, and an inorganic semiconductor located between the first electrode and the second electrode. As another example, the light emitting element EL may be a quantum dot light emitting element that includes a first electrode, a second electrode, and a quantum dot light emitting layer located between the first electrode and the second electrode. As another example, the light emitting element EL may be a micro light emitting diode.

The first electrode of the light emitting element EL may be connected to a fourth node N4. The first electrode of the light emitting element EL may be connected to a drain electrode of the sixth transistor T6 and a source electrode of the seventh transistor T7 through the fourth node N4. The second electrode of the light emitting element EL may be electrically connected to the common voltage line VSL. The second electrode of the light emitting element EL may receive a second driving voltage VS (e.g., a low potential voltage) from the common voltage line VSL.

The second transistor T2 may be turned on by a first gate signal GW of the first gate line GWL to electrically connect the data line DL with a first node N1 that is the source electrode of the first transistor T1. The second transistor T2 may be turned on based on the first gate signal to supply a data voltage to the first node N1. A gate electrode of the second transistor T2 may be connected to the first gate line GWL, a source electrode of the second transistor T2 may be connected to the data line DL, and a drain electrode of the second transistor T2 may be connected to the first node N1.

The third transistor T3 may be turned on by a second gate signal GC of the second gate line GCL to electrically connect a second node N2, which is the drain electrode of the first transistor T1, with a third node N3 that is the gate electrode of the first transistor T1. The third transistor T3 may be connected between the third node N3 and the second node N2. For example, a gate electrode of the third transistor T3 may be electrically connected to the second gate line GCL, a source electrode of the third transistor T3 may be connected to the third node N3, and a drain electrode of the third transistor T3 may be connected to the second node. The third transistor T3 may be turned on by the second gate signal of the second gate line GCL to electrically connect the second node N2, which is the drain electrode of the first transistor T1, with the third node N3 that is the gate electrode of the first transistor T1. The third transistor T3 may be a double gate transistor having two gate electrodes (e.g., a gate electrode and an opposite gate electrode). The gate electrode and the opposite gate electrode may be located on different layers to face each other.

The fourth transistor T4 may be turned on by a third gate signal GI of the third gate line GIL to electrically connect the third node N3, which is the gate electrode of the first transistor T1, with the first initialization voltage line VIL1. The fourth transistor T4 may be connected in series between the third node N3 and the first initialization voltage line VIL1. For example, a gate electrode of the fourth transistor T4 may be electrically connected to the third gate line GIL, a source electrode of the fourth transistor T4 may be electrically connected to the third node N3, and a drain electrode of the fourth transistor T4 may be electrically connected to the first initialization voltage line VIL1. The fourth transistor T4 may be a double gate transistor. The first initialization voltage line VIL1 may transmit the first initialization voltage VI1

According to some embodiments, the first initialization voltage VI1 may have different values in the first mode and the second mode. For example, when the display device 1 is driven in the first mode, the first initialization voltage VI1 may have a voltage having a magnitude at which the first transistor T1 may be turned on, and when the display device 1 is driven in the second mode, the first initialization voltage may have a voltage having a magnitude at which the first transistor T1 may be turned off. For example, as shown in FIG. 9, when the first transistor T1 is a P-type transistor, the first initialization voltage VI1 may be a voltage of a negative polarity in the first mode, and the first initialization voltage VI1 may be a voltage of a positive polarity in the second mode. Meanwhile, when the first transistor T1 is an N-type transistor, the first initialization voltage VI1 may be a voltage of a positive polarity in the first mode, and the first initialization voltage VI1 may be a voltage of a negative polarity in the second mode.

The fifth transistor T5 may be turned on by the emission control signal EM of the emission control line EML to electrically connect the driving voltage line VDDL with the first node N1 that is the source electrode of the first transistor T1. A gate electrode of the fifth transistor T5 may be electrically connected to the emission control line EML, a source electrode of the fifth transistor T5 may be electrically connected to the driving voltage line VDDL, and a drain electrode of the fifth transistor T5 may be connected to the first node N1.

The sixth transistor T6 may be turned on by the emission control signal of the emission control line EML to electrically connect the second node N2, which is the drain electrode of the first transistor T1, with the fourth node N4 that is the first electrode of the light emitting element EL. A gate electrode of the sixth transistor T6 may be connected to the emission control line EML, a source electrode of the sixth transistor T6 may be connected to the second node N2, and a drain electrode of the sixth transistor T6 may be connected to the fourth node N4.

When the fifth transistor T5, the first transistor T1 and the sixth transistor T6 are all turned on, the driving current may be supplied to the light emitting element EL.

The seventh transistor T7 may be turned on by a fourth gate signal EB of the fourth gate line GBL to electrically connect the fourth node N4, which is the first electrode of the light emitting element EL, with the anode initialization voltage line AIL. The seventh transistor T7 may be turned on based on the fourth gate signal to discharge the first electrode of the light emitting element EL with an anode initialization voltage AI. A gate electrode of the seventh transistor T7 may be electrically connected to the fourth gate line GBL, a source electrode of the seventh transistor T7 may be electrically connected to the fourth node N4, and a drain electrode of the seventh transistor T7 may be electrically connected to the anode initialization voltage line AIL. The anode initialization voltage line AIL may transmit the anode initialization voltage AI.

The eighth transistor T8 may be turned on by the fourth gate signal EB of the fourth gate line GBL to electrically connect the bias voltage line VBL with the first node N1 that is the source electrode of the first transistor T1. The eighth transistor T8 may be turned on based on the fourth gate signal to supply a bias voltage VB to the first node N1. The eighth transistor T8 may relatively improve hysteresis of the first transistor T1 by supplying the bias voltage VB to the source electrode of the first transistor T1. A gate electrode of the eighth transistor T8 may be electrically connected to the fourth gate line EBL, a source electrode of the eighth transistor T8 may be electrically connected to the bias voltage line VBL, and a drain electrode of the eighth transistor T8 may be electrically connected to the first node N1.

Each of the first transistor T1, the second transistor T2, the fifth transistor T5, the sixth transistor T6, the seventh transistor T7 and the eighth transistor T8 may include a silicon-based active layer. For example, each of the first transistor T1, the second transistor T2, the fifth transistor T5, the sixth transistor T6, the seventh transistor T7 and the eighth transistor T8 may be a p-type transistor that includes an active layer made of low temperature polycrystalline silicon (LTPS). The active layer made of low temperature polycrystalline silicon may have high electron mobility and excellent turn-on characteristics. Therefore, the display device 1 includes the transistors having excellent turn-on characteristics, thereby stably and efficiently driving the plurality of pixels PX. Each of the first transistor T1, the second transistor T2, the fifth transistor T5, the sixth transistor T6, the seventh transistor T7 and the eighth transistor T8 may output a current flowing into the source electrode, to the drain electrode based on a gate low voltage applied to the gate electrode.

Each of the third transistor T3 and the fourth transistor T4 may be an n-type transistor that includes an oxide-based active layer. For example, the transistor that includes an oxide-based active layer may have a coplanar structure in which a gate electrode is located thereon. The transistor that includes the oxide-based active layer may output a current flowing into the drain electrode to the source electrode based on a gate high voltage applied to the gate electrode.

The capacitor Cst may be electrically connected between the third node N3, which is the gate electrode of the first transistor T1, and the driving voltage line VDL. For example, a first electrode of the capacitor Cst may be electrically connected to the third node N3, and a second electrode of the capacitor Cst may be electrically connected to the driving voltage line VDL, whereby a potential difference between the driving voltage line VDL and the gate electrode of the first transistor T1 may be maintained.

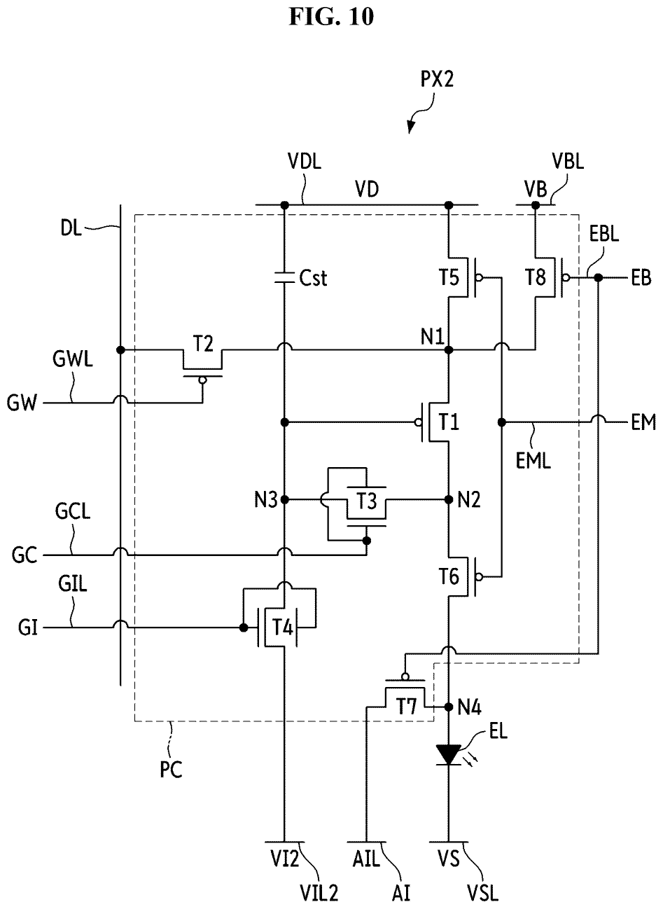

FIG. 10 is a view illustrating an equivalent circuit of pixels included in a narrow rendering group NRG. For example, FIG. 10 may be an equivalent circuit of any one pixel (e.g., the second pixel PX2) included in the narrow rendering group NRG of FIG. 3. Although FIG. 10 illustrates various components in a pixel according to some embodiments, embodiments according to the present disclosure are not limited thereto, and according to some embodiments, the pixel may include additional components or fewer components without departing from the spirit and scope of embodiments according to the present disclosure.

As shown in FIG. 10, the second pixel PX2 may be connected to a first gate line GWL, a second gate line GCL, a third gate line GIL, a fourth gate line EBL, an emission control line EML, a data line DL, a driving voltage line VDL, a common voltage line VDL, a second initialization voltage line VIL2, an anode initialization voltage line AIL and a bias voltage line VBL.

As shown in FIG. 10, the second pixel PX2 may include a pixel circuit PC and a light emitting element EL. The pixel circuit PC and the light emitting element EL of the second pixel PX2 may have the same configuration as that of the pixel circuit PC and the light emitting element EL of the first pixel PX described above.

The pixel circuit PC of the second pixel PX2 may include first to eighth transistors T1 to T8. The first to eighth transistors T1 to T8 provided in the pixel circuit PC of the second pixel PX2 are the same as the first to eighth transistors T1 to T8 provided in the pixel circuit PC of the first pixel PX1 described above, respectively.

However, unlike the fourth transistor T4 of the first pixel PX1, the fourth transistor T4 of the second pixel PX2 may be connected to the second initialization voltage line VIL2 instead of the first initialization voltage line VIL1. For example, the fourth transistor T4 of the second pixel PX2 may include a source electrode connected to the second initialization voltage line VIL2. The second initialization voltage line VIL2 may transmit the second initialization voltage VI2.

According to some embodiments, the second initialization voltage VI2 may have the same magnitude regardless of the first mode and the second mode. For example, when the display device 1 is driven in the first mode or the second mode, the second initialization voltage VI2 may have a voltage having a magnitude capable of turning on the first transistor T1 of the second pixel PX2. For example, as shown in FIG. 10, when the first transistor T1 of the second pixel PX2 is a P-type transistor, the second initialization voltage VI2 may be a voltage of a negative polarity in the first mode and the second mode. Meanwhile, when the first transistor T1 of the second pixel PX2 is an N-type transistor, the second initialization voltage VI2 may be a voltage of a positive polarity in the first mode and the second mode.

The second initialization voltage VI2 may have, for example, the same magnitude as that of the first initialization voltage VI1 in the first mode. For example, the second initialization voltage VI2 may have the same polarity and magnitude as those of the first initialization voltage VI1 in the first mode.

For example, the second initialization voltage VI2 may have a magnitude different from that of the first initialization voltage VI1 in the second mode. For example, the second initialization voltage VI2 may have an opposite polarity and a different magnitude from the first initialization voltage VI1 in the second mode.

The first pixel PX1 and the second pixel PX2 may be connected to the same data line DL. For example, the second transistor T2 of the first pixel PX1 and the second transistor T2 of the second pixel PX2 may be connected to one same data line DL.

The first pixel PX1 and the second pixel PX2 may be connected to different gate lines. For example, the first gate line GWL, the second gate line GCL, the third gate line GIL, the fourth gate line EBL and the emission control line EML, which are connected to the first pixel PX1, may be different from the first gate line GWL, the second gate line GCL, the third gate line EBL and the emission control line EML, which are connected to the second pixel PX2, respectively. Accordingly, the first pixel PX1 and the second pixel PX2 may be applied with gate signals at different timings.

As the first pixel PX1 and the second pixel PX2 are applied with different initialization voltages VI1 and VI2 as described above, in the first mode, both the light emitting element EL of the first pixel PX1 and the light emitting element EL of the second pixel PX2 are turned on, whereas the light emitting element EL of the first pixel PX1 may be turned off in the second mode, and the light emitting element EL of the second pixel PX2 may be turned on. In other words, in the second mode, the light emitting element EL of the first pixel PX1 may not emit light, and the light emitting element EL of the second pixel PX2 may emit light.

For example, when the fourth transistor T4 of the first pixel PX1 is turned on in the first mode, the first initialization voltage VI1 of a negative polarity may be applied to the gate electrode of the first transistor T1 provided in the first pixel PX1 through the turned-on fourth transistor T4. Therefore, the first transistor T1 of the first pixel PX1 may be turned on in the first mode. As the driving current is supplied to the light emitting element EL of the first pixel PX1 through the turned-on first transistor T1 of the first pixel PX1, the light emitting element EL of the first pixel PX1 may be turned on.

On the other hand, in the second mode, when the fourth transistor T4 of the first pixel PX1 is turned on, the first initialization voltage VI1 of a positive polarity may be applied to the gate electrode of the first transistor T1 provided in the first pixel PX1 through the turned-on fourth transistor t4. Therefore, in the second mode, the first transistor T1 of the first pixel PX1 may be turned off. As a result, because the driving current is not supplied to the light emitting element EL of the first pixel PX1, the light emitting element EL of the first pixel PX1 may be turned off.

Meanwhile, because the second initialization voltage VI2 supplied to the fourth transistor T4 of the second pixel PX2 is a voltage of a negative polarity in both the first mode and the second mode, the second initialization voltage VI2 of a negative polarity may be always applied to the gate electrode of the first transistor T1 of the second pixel PX2 in the first mode and the second mode. Therefore, in the first mode and the second mode, the light emitting element EL of the second pixel PX2 may be turned on.

According to some embodiments, in the second mode, a data signal corresponding to the second pixel PX2 may be applied to the data line DL. For example, in the second mode, when the first pixel PX1 is driven for a first period and the second pixel PX2 is driven for a second period, the same data signal (e.g., a data voltage of a full white gray scale) may be applied to the data line DL for the first period and the second period. Therefore, in the second mode, the first pixel PX1 and the second pixel PX2 may be supplied with the same data signal. However, in the second mode, because the first transistor T1 of the first pixel PX1 is turned off and the first transistor T1 of the second pixel PX2 is turned on, the light emitting element EL of the first pixel PX1 does not emit light in the second mode. In other words, even though the same data signal is applied to the first pixel PX1 and the second pixel PX2 in the second mode, the light emitting element EL of the first pixel PX1 may be maintained in the turned-off state in the second mode.

Therefore, in a display device 1 according to some embodiments, because there is no substantial change in the data signal between the first period and the second period of the second mode, even though the pixels (e.g., PX1) of the wide rendering group WDG and the pixels (e.g., PX2) of the narrow rendering group NRG are driven differently, power consumption of the display device 1 may be relatively reduced.

Meanwhile, in the first mode, the first data signal corresponding to the first pixel PX1 may be applied to the data line DL for the first period, and the second data signal corresponding to the second pixel PX2 may be applied to the data line DL for the second period.

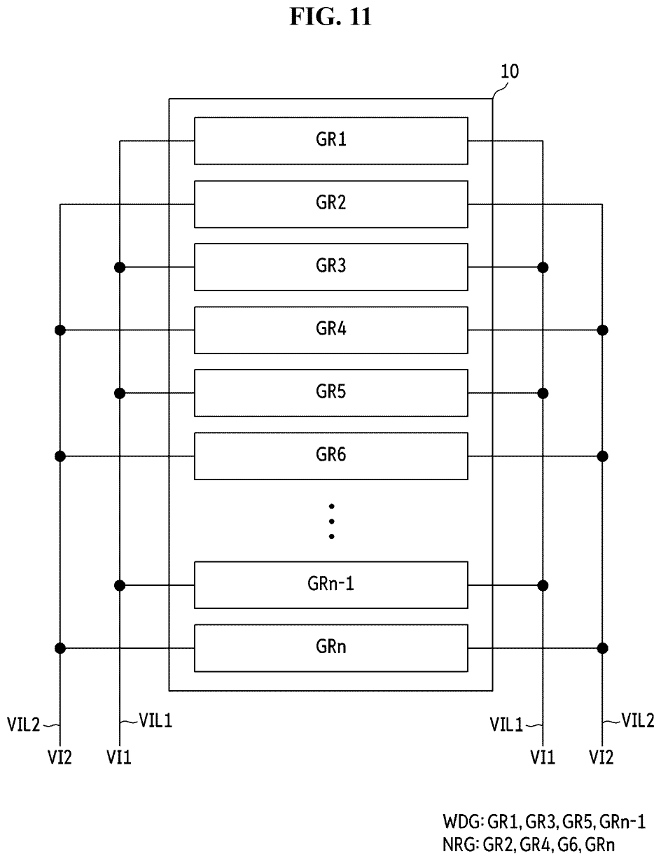

FIG. 11 is a view illustrating initialization voltage lines connected to pixels of a wide rendering group WDG and pixels of a narrow rendering group NRG in a display device according to some embodiments.

As shown in FIG. 11, the first pixels PX1 of the wide rendering group WDG may be connected in common to the first initialization voltage line VIL1, and the second pixels PX2 of the narrow rendering group NRG may be connected in common to the second initialization voltage line VIL2. For example, the first pixels PX1 of the first rendering group GR1, the third rendering group GR3, the fifth rendering group GR5, . . . , (n−1)th rendering group GRn−1 may be connected in common to the first initialization voltage line VIL1, and the second pixels PX2 of the second rendering group GR2, the fourth rendering group GR4, the sixth rendering group GR6, . . . , (n)th rendering group GRn may be connected in common to the second initialization voltage line VIL2. In this case, ‘n’ is an even number equal to or greater than 8.

As described above, the first initialization voltage line VIL1 may transmit the first initialization voltage VI1 of a negative polarity in the first mode and transmit the first initialization voltage VI1 of a positive polarity in the second mode.

Meanwhile, the second initialization voltage line VIL2 may transmit the second initialization voltage VI2 of a negative polarity in both the first mode and the second mode.

The display device according to the embodiment can be applied to various electronic devices. The electronic device according to one embodiment includes the display device described above and may further include modules or devices having additional functions in addition to the display device.

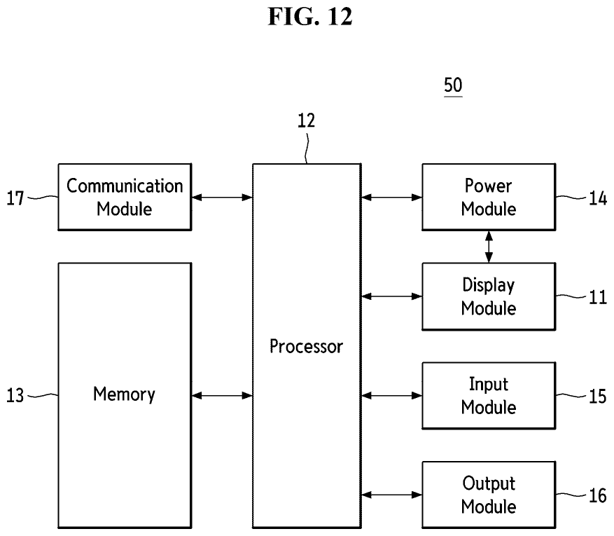

FIG. 12 is a block diagram of an electronic device according to one embodiment. Referring to FIG. 12, the electronic device 50 according to one embodiment may include a display module, a processor 12, a memory 13, and a power module 14. The electronic device 5000 may further include an input module 14, a non-image output module 15 and/or a communication module 16.

The electronic device 50 may output various information in the form of images through the display module 11. When the processor 12 executes an application stored in the memory 13, image information provided by the application may be provided to the user through the display module 1100. The power module 14 may include a power supply module such as a power adapter or a battery device, and a power conversion module that converts the power supplied by the power supply module to generate power required for the operation of the electronic device 5000. The input module 14 may provide input information to the processor 12 and/or the display module 11. The non-image output module 15 may receive information other than images transmitted from the processor 12, such as sound, haptics, and light, and provide the information to the user. The communication module 16 is a module that is responsible for transmitting and receiving information between the electronic device 5000 and an external device, and may include a receiving unit and a transmitting unit.

At least one of the components of the electronic device 50 described above may be included in the display device according to the embodiments described above. In addition, some of the individual modules functionally included in one module may be included in the display device, and others may be provided separately from the display device. For example, the display device includes a display module 11, and the processor 12, memory 13, and power module 14 may be provided in the form of other devices within the electronic device 11 other than the display device.

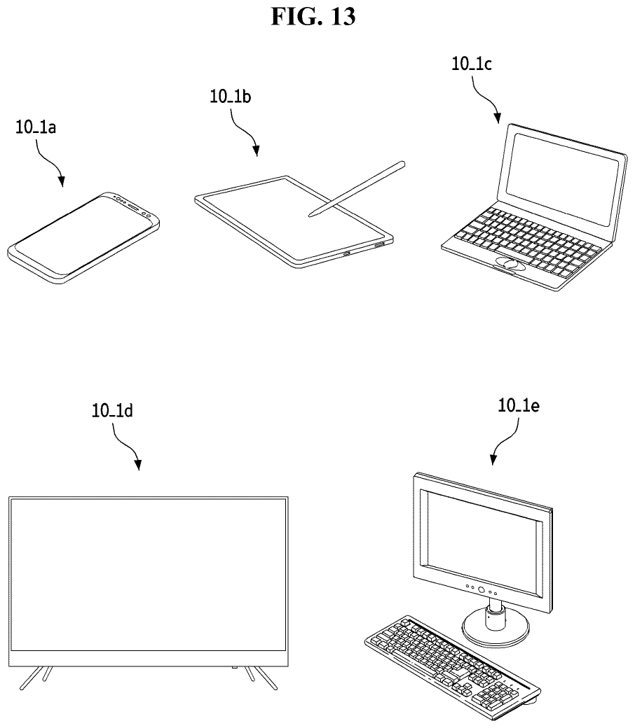

FIGS. 13, 14, and 15 are schematic diagrams of electronic devices according to various embodiments. FIGS. 13 to 15 illustrate examples of various electronic devices to which the display device according to the embodiments is applied.

FIG. 13 illustrates a smartphone 10_1a, a tablet PC 10_1b, a laptop 10_1c, a TV 10_1d, and a desk monitor 10_1e as examples of electronic devices.

In addition to the display module 11, the smartphone 10_1a may include an input module such as a touch sensor and a communication module. The smartphone 10_1a may process information received through the communication module or other input modules and display the information through the display module of the display device.

In the case of tablet PCs 10_1b, laptops 10_1c, TVs 10_1d, and desk monitors 10_1e, they also include display modules and input modules similar to smartphones 10_1, and may additionally include communication modules in some cases.

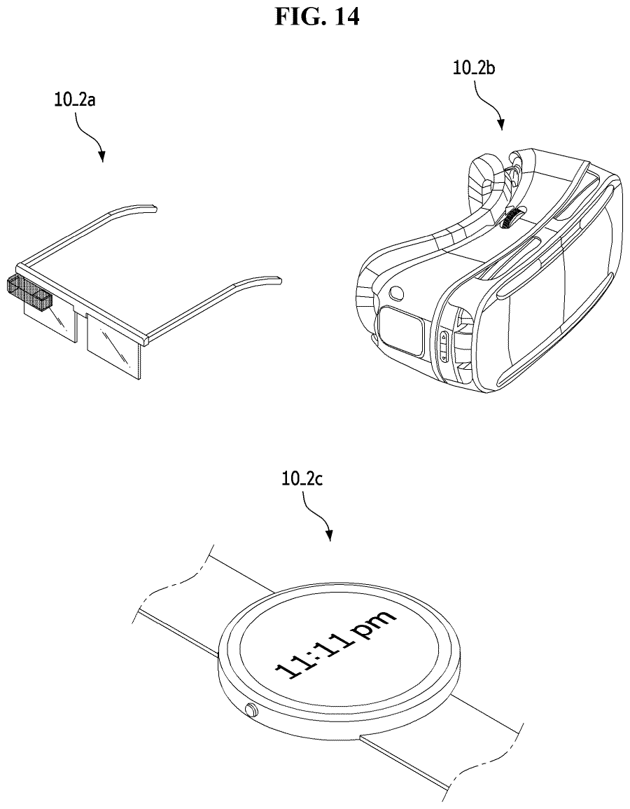

FIG. 14 shows an example of an electronic device including a display module being applied to a wearable electronic device. The wearable electronic device may be a smart glasses 10_2a, a head-mounted display 10_2b, a smart watch 10_2c, etc.

The smart glasses 10_2a and the head-mounted display 10_2b may include a display module that emits a display image and a reflector that reflects the emitted display screen and provides it to the user's eyes, thereby providing a virtual reality or augmented reality screen to the user.

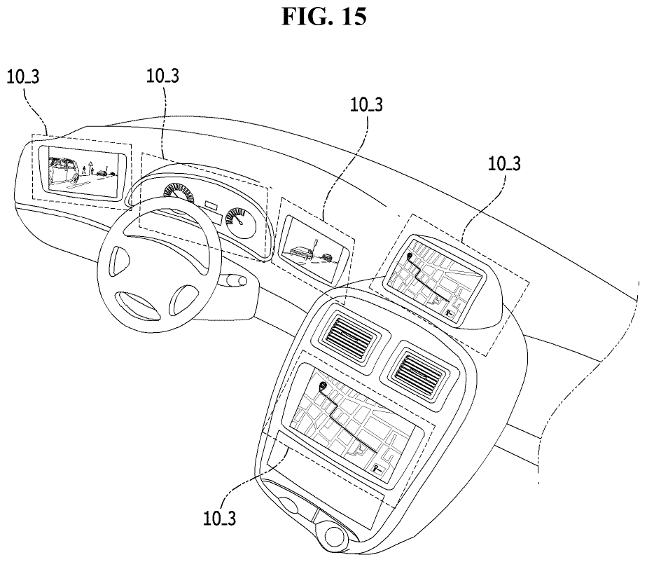

The smart watch 10_2c includes a biometric sensor as an input device, and may provide biometric information recognized by the biometric sensor to the user through the display module. FIG. 15 illustrates a case where an electronic device including a display module is applied to a vehicle. For example, the electronic device 10_3 may be applied to a dashboard, center fascia, etc. of a vehicle, or may be applied to a CID (Center Information Display) placed on a dashboard of a vehicle, or a room mirror display replacing a side mirror.

It will be able to be understood by one of ordinary skill in the art to which the present disclosure belongs that the present disclosure may be implemented in other specific forms without changing the technical spirit or essential features of the present disclosure. Therefore, it is to be understood that the disclosed embodiments described above are illustrative rather than being restrictive in all aspects. It is to be understood that the scope of embodiments according to the present disclosure are defined by the claims rather than the detailed description described above and all modifications and alterations derived from the claims and their equivalents fall within the scope of embodiments according to the present disclosure.

What is claimed is:

1. A display device comprising:
a substrate;
a first pixel on the substrate and not surrounded by a light blocking layer;
a second pixel on the substrate and surrounded by the light blocking layer;
a data line connected to the first pixel and the second pixel;
a first gate line connected to the first pixel;
a second gate line connected to the second pixel;
a first initialization voltage line connected to the first pixel, and configured to transmit a first initialization voltage; and
a second initialization voltage line connected to the second pixel, and configured to transmit a second initialization voltage,
wherein, in a first mode, the first initialization voltage has a voltage of a magnitude capable of turning on a first transistor of the first pixel,
in a second mode, the first initialization voltage has a voltage of a magnitude capable of turning off the first transistor of the first pixel, and
in the first mode and the second mode, the second initialization voltage has a voltage of a magnitude capable of turning on the first transistor of the second pixel.

2. The display device of claim 1, wherein the second initialization voltage has a same magnitude as that of the first initialization voltage in the first mode.

3. The display device of claim 2, wherein the second initialization voltage has a same polarity and magnitude as those of the first initialization voltage in the first mode.

4. The display device of claim 1, wherein the second initialization voltage has a magnitude different from that of the first initialization voltage in the second mode.

5. The display device of claim 4, wherein the second initialization voltage has an opposite polarity and a different magnitude from the first initialization voltage in the second mode.

6. The display device of claim 1, wherein each of the first transistor of the first pixel and a second transistor of the second pixel is a P-type transistor.

7. The display device of claim 6, wherein the first initialization voltage is a voltage of a negative polarity in the first mode.

8. The display device of claim 6, wherein the first initialization voltage is a voltage of a positive polarity in the second mode.

9. The display device of claim 6, wherein the second initialization voltage is a voltage of a negative polarity in the first mode and the second mode.

10. The display device of claim 1, wherein each of the first transistor of the first pixel and the first transistor of the second pixel is an N-type transistor.

11. The display device of claim 10, wherein the first initialization voltage is a voltage of a positive polarity in the first mode.

12. The display device of claim 10, wherein the first initialization voltage is a voltage of a negative polarity in the second mode.

13. The display device of claim 10, wherein the second initialization voltage is a voltage of a positive polarity in the first mode and the second mode.

14. The display device of claim 1, wherein the first pixel further includes:
a light emitting element connected to the first transistor of the first pixel; and
a second transistor connected to a gate electrode of the first transistor of the first pixel and the first initialization voltage line.

15. The display device of claim 1, wherein the second pixel further includes:
a light emitting element connected to the first transistor of the second pixel; and
a second transistor connected to a gate electrode of the first transistor of the second pixel and the second initialization voltage line.

16. The display device of claim 1, wherein, in the first mode, a first data signal corresponding to the first pixel is applied to the data line for a first period, and
in the first mode, a second data signal corresponding to the second pixel is applied to the data line for a second period.

17. The display device of claim 1, wherein, in the second mode, a data signal corresponding to the second pixel is applied to the data line.

18. The display device of claim 1, wherein the first pixel is included in any one of an odd-numbered rendering group and an even-numbered rendering group, and
the second pixel is included in the other one of the odd-numbered rendering group and the even-numbered rendering group.

19. The display device of claim 1, wherein, in the first mode, the first pixel and the second pixel are configured to be turned on, respectively,
wherein, in the second mode, the first pixel is turned off and the second pixel is configured to be turned on.

20. An electronic device comprising:
a display device comprising:
display device comprising:
a substrate;
a first pixel on the substrate and not surrounded by a light blocking layer;
a second pixel on the substrate and surrounded by the light blocking layer;
a data line connected to the first pixel and the second pixel;
a first gate line connected to the first pixel;
a second gate line connected to the second pixel;
a first initialization voltage line connected to the first pixel, and configured to transmit a first initialization voltage; and
a second initialization voltage line connected to the second pixel, and configured to transmit a second initialization voltage,
wherein, in a first mode, the first initialization voltage has a voltage of a magnitude capable of turning on a first transistor of the first pixel,
in a second mode, the first initialization voltage has a voltage of a magnitude capable of turning off the first transistor of the first pixel, and
in the first mode and the second mode, the second initialization voltage has a voltage of a magnitude capable of turning on the first transistor of the second pixel.
